(19) United States
(12) Patent Application Publication
(10) Pub. No.: US 2008/0244071 A1
(43) Pub. Date: Oct. 2, 2008

(54) Policy definition using a plurality of configuration items

(75) Inventors: Gopal Parupudi, Issaquah, WA (US); Sangeetha Visweswaran, Redmond, WA (US); Mukunda Murthy, Sammamish, WA (US); Khuzaima Iqbal, Issaquah, WA (US); Rajagopalan Badri Narayanan, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,278

(22) Filed: Mar. 27, 2007

(51) Int. Cl. G06F 15/173

(52) U.S. Cl. 709/226

(57) ABSTRACT

Policy definition using a plurality of configuration items is described. In one or more implementations, a plurality of policies is defined, each having a different combination of a plurality of configuration items. The policies are then implemented such that each of the clients is provided a respective amount of access to one or more resources based on compliance with applicable policies.

### BACKGROUND

Use of computers has become ubiquitous in both personal and work settings. Additionally, users have access to a wide range of computers in each of these settings, from traditional desktop personal computers to laptops, personal digital assistants (PDAs), “smart” phones, set-top boxes and so on. Further, each of the computers may assume a variety of configurations that are targeted towards different functionality, such as through use by different parts in a company's structure and therefore employ different hardware and/or software capabilities. Thus, users may interact with a wide range of computers, each having a variety of configurations.

Because of this variety of configurations, however, management of the computers continues to increase in complexity. For example, an administrator may be tasked with managing thousands of computers in an, enterprise environment. However, traditional techniques that were made available to the administrator to manage these computers did not address the different configurations that may be employed by the computers. Therefore, the administrator was often prevented from dealing with issues on an overall compliance basis.

### SUMMARY

Policy definition using a plurality of configuration items is described. In one or more implementations, a plurality of policies is defined, each having a different combination of a plurality of configuration items. The policies are then implemented such that each of the clients is provided a respective amount of access to one or more resources based on compliance with applicable policies.

In additional implementations, data is examined that describes configuration items of one or more clients to determine a relative level of compliance of the one or more clients with a policy. One of a plurality of different actions is then applied to respective clients based on the determined level of compliance.

In further implementations, configuration items of a plurality of clients are monitored to determine compliance with one or more policies. When a deviation is detected in one or more configuration items, a change is made to the one or more configuration items automatically and without user intervention such that a respective client complies with a respective policy.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an exemplary implementation that is operable to employ policy definition using a plurality of configuration items.

FIG. 2 is an illustration showing the environment of FIG. 1 as being implemented as an exemplary enterprise system within a corporation.

FIG. 3 is a flow diagram depicting a procedure in an exemplary implementation in which policies are created using a plurality of configuration items and implemented such that a client is provided access to a resource based on compliance with the policies.

FIG. 4 is a flow diagram depicting a procedure in an exemplary implementation in which an administrator uses policies to manage clients and apply actions to the clients based on compliance with the policies.

FIG. 5 is a flow diagram depicting a procedure in an exemplary implementation in which remedial action is taken to protect against an identified vulnerability of a client through use of a policy automatically and without user intervention.

### DETAILED DESCRIPTION

### Overview

Users have access to a variety of computers having a wide range of configurations. For example, computers may be targeted towards different functionality and therefore employ different hardware, software and/or network capabilities. Because of this, however, management of the computers continues to increase in complexity. Traditional techniques that were available to manage these computers, however, did not address the different configurations that are employed by the computers. Therefore, the administrator was often prevented from dealing with issues on an overall compliance basis.

Techniques are described, in which, a policy is defined using a plurality of configuration items. For example, an administrator of an enterprise system may be confronted with a variety of computer configurations that are particular to various aspects of a corresponding business, such as sales, human resources, software developers, and so on. Each of the configurations may have one or more configurations items that are different, such as different amounts of network access permitted, access to particular applications, and so on. Accordingly, the administrator may identify configuration items (e.g., software, hardware and/or network resources and settings) that are particular to these various groups and define policies accordingly that may maintain the “health” (e.g., desired functionality) of the computers. In this way, the administrator may use “rich” definitions to manage functionality of devices within a network, further discussion of which may be found in relation to the following figures.

In the following discussion, an exemplary environment is first described which is operable to employ techniques to define policies using a plurality of configuration items. Exemplary procedures are then described which may be employed in the exemplary environment, as well as in other environments.

### EXEMPLARY ENVIRONMENT

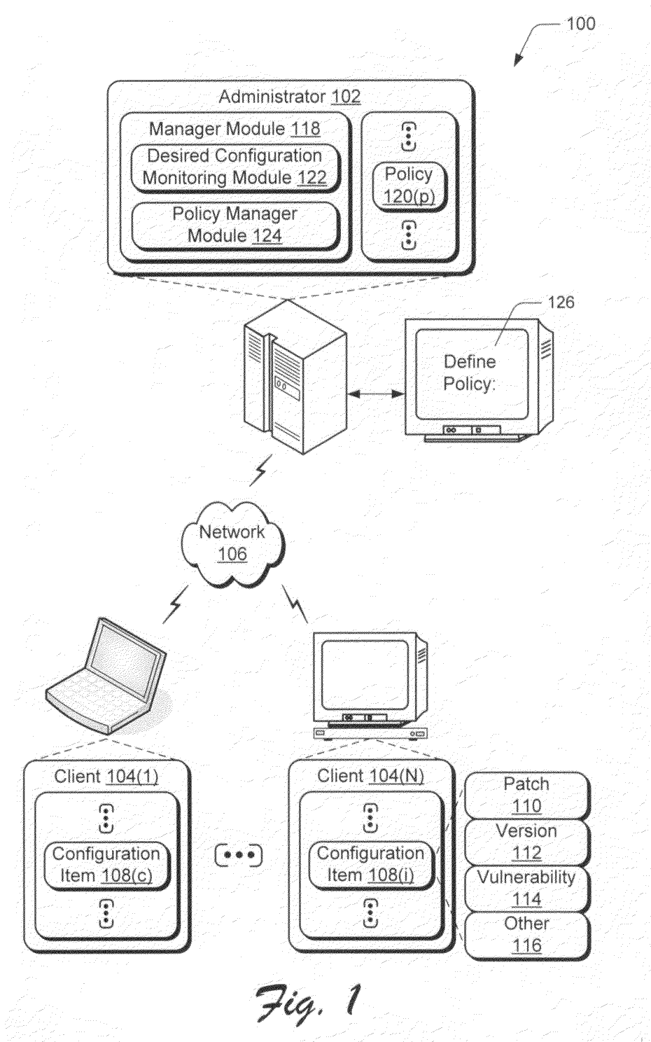

FIG. 1 is an illustration of an environment 100 in an exemplary implementation that is operable to employ policy definition using a plurality of configuration items. The illustrated environment 100 includes an administrator 102 and a plurality of clients 104(1)-104(N) that are communicatively coupled, one to another, via a network 106. Although the network 106 is illustrated as the Internet, the network may assume a wide variety of configurations. For example, the network 106 may include a wide area network (WAN), a local area network (LAN), a wireless network, a public telephone network, an intranet, and so on. Further, although a single network 106 is shown, the network 106 may be configured to include multiple networks. Thus, the environment 100 may be illustrative of a variety of different environments, such as an enterprise environment that is employed by a corporation, educational institution, and so on.

The clients 104(n) may be configured in a variety of ways. For example, the client 104 may be configured as a computer that is capable of communicating over the network 106, such as a desktop computer, a mobile station, an entertainment appliance, a set-top box communicatively coupled to a display device, a wireless phone, a game console, and so forth. Thus, the clients 104(n) may range from full resource devices with substantial memory and processor resources (e.g., personal computers, game consoles) to a low-resource device with limited memory and/or processing resources (e.g., traditional set-top boxes, hand-held game consoles). Although illustrated as being implemented via computers, for purposes of the following discussion the clients 104(1)-104(N) may also relate to software that operates the computer.

Each of the clients 104(1)-104(N) is illustrated as having one or more configuration items 108(c), 108(i) (where “c” and “i” can be any integer from one to “C” and “I”, respectively) that impart the functionality made available by the client 104(1)-104(N) to respective users. For example, the configuration items 108(c), 108(i) may be representative of hardware functionality of the clients 104(1)-104(N), such as processors, memory (e.g., random access memory, hard disk drives), network connection devices, input devices (e.g., mouse, keyboard, microphone), output devices (e.g., speakers, monitors), and so on.

The configuration items 108(c), 108(i) may also be representative of software resources, such as drivers for the respective hardware functionality, applications, executable modules, and so on. Additionally, the configuration items 108(c), 108(i) may be representative of settings employed by these resources, such as registry settings, configuration settings of network software, and so on. Further, the configuration items 108(c), 108(i) may also be representative of functionality made available to the respective clients 104(1), 104(N), such as an amount of bandwidth made available to communicate over the network 106. A variety of other examples are also contemplated. For instance, a configuration item 108(i) may include a patch 110 for an executable module, a version 112 of a software item, an identified vulnerability 114 in hardware or software resources, and other 116 configuration items, such as “strength” of a password. In this way, these configuration items 108(c), 108(i) may together define the functionality available to a user from the respective clients 104(1)-104(N) and how that functionality is provided, and thereby may define the “health” of the respective clients 104(1)-104(N).

The administrator 102 is illustrated as including a manager module 118 which is representative of functionality that may be used to manage the environment 100. For example, the manager module 118 may be used to define and implement one or more policies 120(p) that define desired operation of the respective clients, and thus, whether the clients are “healthy”. Although illustrated as being implemented via a server, the administrator 102 may also relate to a person and/or entity that operate the device, e.g., the server. In other words, for purposes of the following discussion the administrator 102 may describe a logical administrator that includes users, software and/or devices. Further, because the policy 120(p) is representative of one or more policies, reference may be made to the policies in singular or plural form, e.g., the “policy 120(p)” or the “policies 120(p)”.

The administrator 102, and more particularly the manager module 118, is illustrated as including a desired configuration monitoring module 122 (hereinafter “DCM”) and a policy manager module 124. The DCM 122 is representative of functionality to define and monitor the configuration items 108(c), 108(i) of the clients 104(1)-104(N). The DCM 122, for instance, may define different collections of configuration items 108(c), 108(i) and therefore what a “healthy” and consequently an “unhealthy” client 104(1)-104(N) “looks like”.

The policy manager module 124 is representative of functionality to define the policies 120(p) using configuration items 108(c), 108(i). For example, the policy manager module 124 may use the definition of configuration items 108(c), 108(i) for the clients 104(1)-104(N) from the DCM 122 to define policies 120(p). These policies 120(p) may then describe desired functionality of the respective clients 104(i)-104(N), enforcement of which may be used to ensure the clients 104(1)-104(N) and the environment 100 functions as desired.

The administrator 102, for instance, may define one or more policies 120(p) through interaction with a user interface 126 to include multiple levels of “health” such that varying degrees of compliance with the policies 120(p) define corresponding varying levels of health. Compliance with these policies 120(p) may therefore be used as a basis of a determination of the health of the environment 100, and in particular, the health of the respective clients 104(1)-104(N). Enforcement decisions may then be made using results of the compliance, such as to quarantine client 104(1)-104(N) from access to the network 106 based on the relative health of the clients, provide different levels of quality of service, and so on. As previously described, however, the clients 104(1)-104(N) may assume a variety of configurations and therefore the policy 120(p) may not be equally applicable to each of the clients 104(1)-104(N), respectively, as further discussed in relation to the following figure.

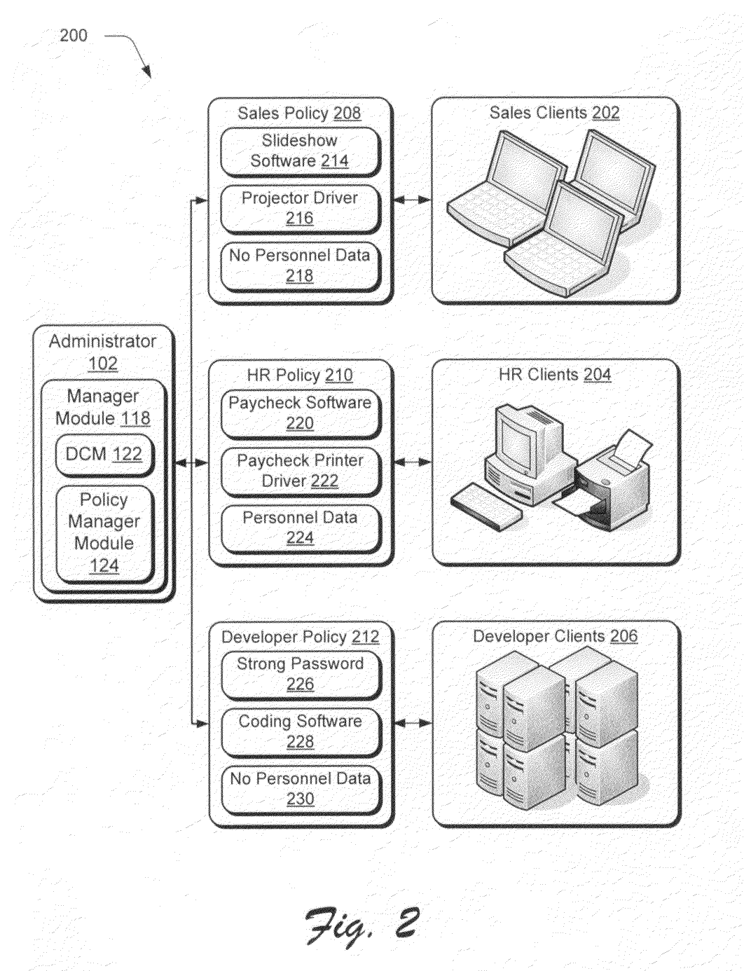

Reference will now be made to FIG. 2 which shows the environment 100 of FIG. 1 as being implemented as an exemplary enterprise system 200 within a corporation. As previously described, the clients 104(1)-104(N) of FIG. 1 may be configured in a variety of different ways through inclusion of a variety of different configuration items. In the illustrated enterprise system 200 of FIG. 2, for instance, the clients may be configured as sales clients 202, human resources (HR) clients 204 and developer clients 206. Consequently, each of these different groups of clients within the organization may have different configurations to provide the functionality desired by respective users, e.g., sales, HR and developers.

Accordingly, the administrator 102 may define policies through use of the DCM 122 and policy manager module 124 of the manager module 118 to manage the enterprise system 200. For example, the policy manager module 124 may be executed by the administrator 102 to define policies for groups within a business organization, such as a sales policy 208 for the sales clients 202, an HR policy 210 for the HR clients 204 and a developer policy 212 for the developer clients 206.

The sales policy 208, for instance, may specify that slideshow software 214 and a projector driver 216 are to be included on the sales clients 202, but personnel data 218 is not permitted. The HR policy 210 may specify that paycheck software and a paycheck printer driver 222 are to be included on the HR clients 204, and personnel data 224 is also permitted. The developer policy 212 may specify that the developer clients 206 are to include a strong password 226 and coding software 228 but no personnel data 230. In this way, the administrator 102 is able to model the different collections of configuration items of the respective clients, which may then be used to enforce the policies.

The administrator 102, for example, may define configurations having particular sets of configuration items, rules to be used to manage these configurations and levels of violations on those rules through the use of policies. The configuration definitions may thus range from generic definitions (e.g., a security configuration) to specific operating system, installed software and software patch installation configurations.

The DCM 122 may also be extended to enforce these policies, such as through network enforcement in which a level of enforcement is defined (e.g., no network access, partial network access/access to specific machines, full network access with auditing, full network access with repeated reminders set) associated with each level of compliance/violation. For example, the DCM 122 may employ “set” functionality to define remediation rules (e.g., disable guest account, install patch, etc.) to address vulnerabilities, such as weak passwords, guest account enabled, no screen saver password, and so on. In this way, the administrator 102 is provided with a comprehensive tool that may manage the variety of configurations that may be encountered within an environment (e.g., the environment 100 of FIG. 1 and the enterprise system 200 of FIG. 2), further discussion of which may be found in relation to the following procedures.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the policy definition techniques described below are platform-independent, meaning that the techniques may be implemented on a variety of commercial computing platforms having a variety of processors.

### EXEMPLARY PROCEDURES

The following discussion describes policy definition techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the enterprise system 200 of FIG. 2.

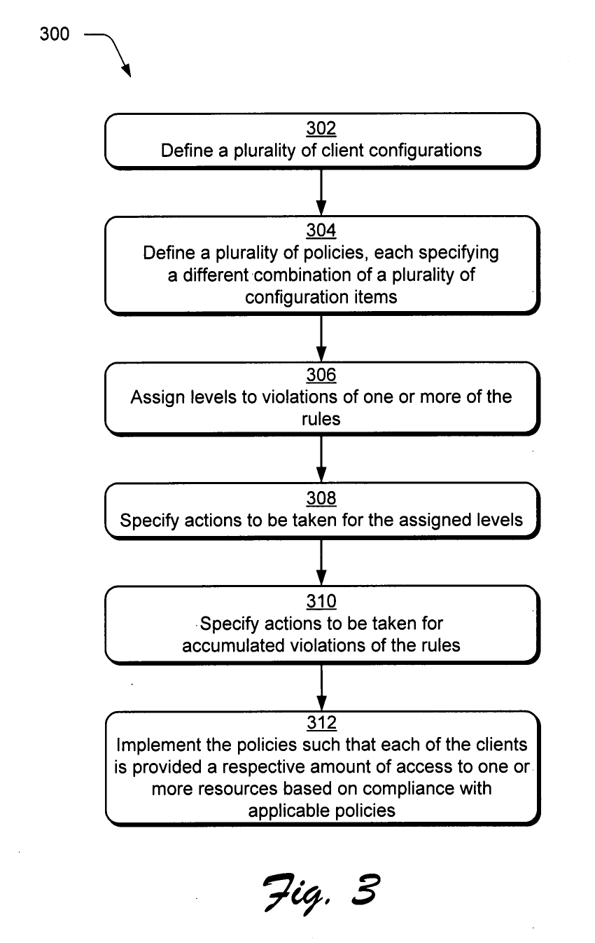

FIG. 3 depicts a procedure 300 in an exemplary implementation in which policies are created using a plurality of configuration items and implemented such that a client is provided access to a resource based on compliance with the policies. A plurality of client configurations is defined (block 302). The administrator 102, for instance, may determine that a client to be used by human resources personnel should include paycheck software 220, a paycheck printer driver 222 and be permitted to store personnel data 224. A client to be used by a salesperson, however, should include slideshow software 214 and a projector driver 216 but no personnel data 218. This definition may be based on functionality of the clients 104(1)-104(N) that may be monitored through use of the DCM 122.

A plurality of policies are defined, each specifying a different combination of a plurality of configuration items (block 304). The administrator 102, for instance may determine certain configuration items are to be present for a client to be considered healthy, such as a “strong” password, network use restricted to access of a particular domain, incorporation by an application of one or more patches, disabling a guest account, and so on. Rules may then be written which detail these configuration items for inclusion in a policy.

Levels may then be assigned to violations of one or more of the rules (block 306). For example, the administrator 102 may consider a violation of a rule specifying a “strong” password to be relatively minor, while a violation of a rule specifying an update of virus protection software to be relatively major. Therefore, the administrator may “weight” these violations and thereby create different levels of compliance with the rules and thus the policy as a whole. These levels may be specified in a variety of ways. For example, the administrator 102 may specify levels to a particular configuration item (e.g., strong vs. moderate vs. weak password) as well as collections of configuration items (e.g., password strength and virus protection software update) to arrive at a plurality of levels of compliance with the policy.

Actions may then be specified to be taken for the assigned levels (block 308). Continuing with the previous example, the administrator 102 may specify that full network access is permitted with reminders to change a password when use of a relatively “moderate” password is detected, e.g., an alphabetic dictionary term that does not include non-alphanumeric characters. The administrator may also specify that partial network access is permitted (e.g., to a particular domain) when a “weak” password is detected, e.g., the word “password”.

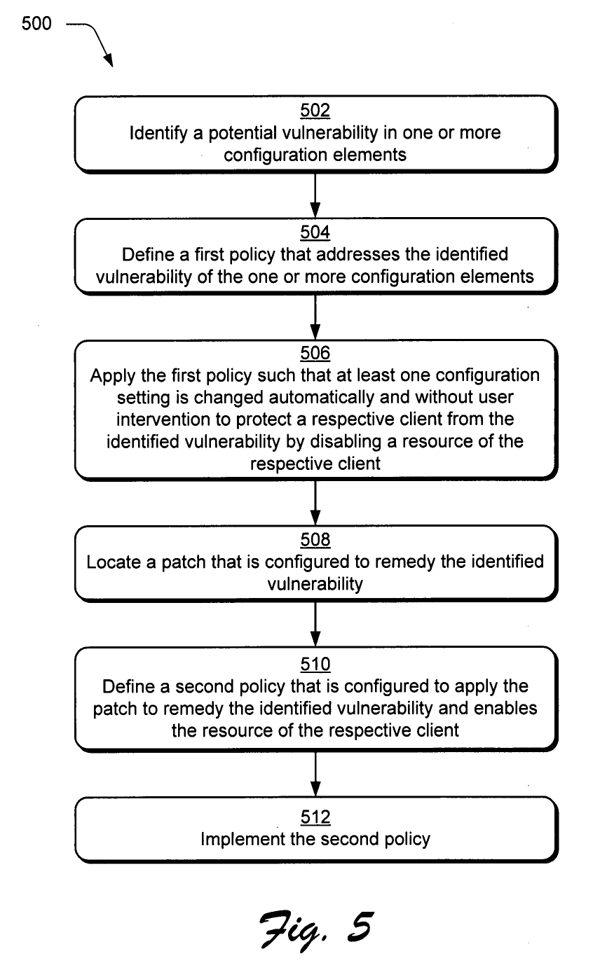

Actions may also be specified for accumulated violations of the rules (block 310). The administrator may specify, for instance, that a weak password and a failure to update virus protection software should result in quarantine from the network 106 while a strong password with a corresponding failure to update the virus protection software should result in limited access to specified devices within the enterprise system 200. A variety of other examples are also contemplated, such as remedial actions that may be specified to “correct” noncompliance with the policies. For example, the administrator 102 may use a “set” feature of the DCM 122 as previously described to define remediation rules, further discussion of which may be found in relation to FIG. 5.

The policies are then implemented such that each of the clients is provided with a respective amount of access to one or more resources based on compliance with applicable policies (block 312). Continuing again with the previous example, the administrator 102, through execution of the manager module 118, may provide different amounts of network 106 access based on the clients' 104(1)-104(N) compliance with policy 120(p) levels, further discussion of which may be found in relation to the following figure.

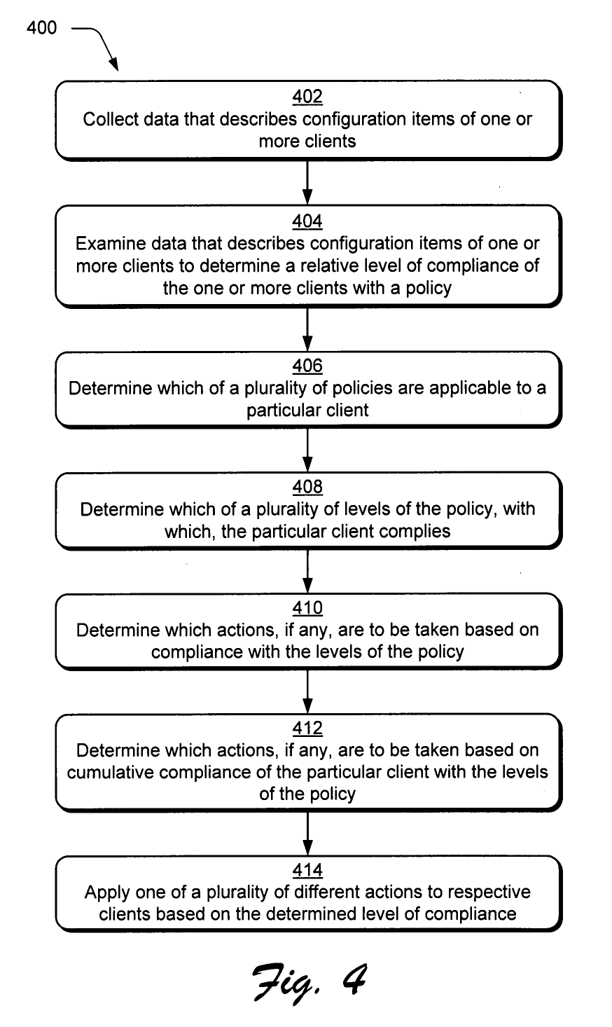

FIG. 4 depicts a procedure 400 in an exemplary implementation in which an administrator uses policies to manage clients and apply actions to the clients based on compliance with the policies. Data is collected that describes configuration items of one or more clients (block 402). The administrator 102, for instance, may execute the DCM 122 to collect data from the clients 104(1)-104(N) by monitoring the configuration of the clients 104(1)-104(N). The clients 104(1)-104(N) may also employ a “push” model in which the clients 104(1)-104(N) themselves report the status of respective configuration items to the administrator 102. A variety of other examples are also contemplated.

The data that describes configuration items of one or more clients is examined to determine a relative level of compliance of the one or more clients when a policy (block 404). In this way, the administrator 102 may determine a deviation from compliance with the policies 120(p). This examination may be performed in a variety of ways.

The administrator 102, for example, through execution of the manager module 118 may determine which of a plurality of policies are applicable to a particular client (block 406). The policies 120(p) may include unique identifiers that are to be matched with particular clients 104 (e.g., a serial number or product key), query for particular functionality that is applicable to the policy (e.g., inclusion of particular hardware or software resources), applied to clients in a particular geographic location (e.g., a lobby of a bank), and so on.

A determination may then be made as to which of a plurality of levels of the policy the particular client complies (block 408). The administrator 102 may examine each of the rules and determine if the corresponding client complies with the rule. If the rule has a plurality of levels, the administrator 102 may also determine the particular level with which the client complies, such as the “weak”, “moderate” and “strong” password levels as previously described. The compliance with the particular rules (and even levels within the rule) may then be used to determine the client's relative compliance with the rules as well as the policy as a whole.

A determination is then made as to which actions, if any, are to be taken based on compliance with the levels of the policy (block 410). The administrator 102, for instance, may specify particular actions to be taken with different levels of compliance with a particular rule of a policy, e.g., a “weak” password warrants limited network access while a “moderate” password warrants a reminder. A variety of other examples are also contemplated, such as impairing, restricting or disabling functionality of the client.

A determination may also be made as to which actions, if any, are to be taken based on cumulative compliance of the particular client with the levels of the policy (block 412). The client, for example, may be in noncompliance with a collection of relatively “minor” rules but the cumulative affect of this noncompliance may be considered significant. Therefore, the policy 120(p) may specify actions to be taken in such an instance, such as to limit network access by lowering an amount of bandwidth made available to the client.

One of a plurality of different actions is then applied to respective clients based on the determined level of compliance (block 414). The actions, for instance, may be applied based on the determination of the applicable levels of a policy (block 410) as well as the cumulative effect of compliance and noncompliance with the policy, e.g., compliance with one or more rules that make up the policy. Thus, the policies may be used to manage clients based on a “rich” definition of functionality of the clients and corresponding “rich” definition of actions that may be performed as a result of the compliance. Although the previous example described levels of compliance and corresponding quarantining of the clients, remedial actions may also be taken, further discussion of which may be found in relation to the following figure.

FIG. 5 is a flow diagram depicting a procedure in an exemplary implementation in which remedial action is taken to protect against an identified vulnerability of a client through use of a policy automatically and without user intervention. A potential vulnerability is identified in one or more configuration elements (block 502). An administrator 102, for instance, may identify a particular configuration element in software that is executed on one or more clients that makes the clients vulnerable to attack from malicious parties, such as from a particular virus.

The administrator may then define a first policy that addresses the identified vulnerability of the one or more configuration elements (block 504). The first policy, for instance, may identify the “vulnerable” configuration element (i.e., the configuration element that makes a respective client vulnerable to attack) and how to disable the element because a “fix” for the identified vulnerability is not currently known.

The first policy is applied such that at least one configuration setting is changed automatically and without user intervention to protect a respective client from the identified vulnerability by disabling a resource of the respective client (block 506). The first policy, for instance, may detect the configuration element and disable the corresponding module to protect the client from attempts by malicious parties to exploit the vulnerability. Therefore, at this point although the client is protected from the identified vulnerability the client forgoes the functionality provided by the corresponding module.

A patch is then located that is configured to remedy the identified vulnerability (block 508), such as by searching a website, coding by the administrator 102, and so on. A second policy is then defined that is configured to apply the patch to remedy the identified vulnerability and that enables the resource of the respective client (block 510). The second policy is then implemented (block 512) thereby returning the client to operation in a manner that is protected from the identified vulnerability. In this way, the administrator 102 may use successive policies 120(p) to manage operation of the clients 104(1)-104(N) to address changes in the operating environment. Although a patch has been described, it should be readily apparent that a wide variety of remedies are also contemplated, such as by installing software, changing an existing configuration setting, and so on.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A computer-implemented method comprising:
defining a plurality of policies, each specifying a different combination of a plurality of configuration items; and
implementing the policies such that each of a plurality of clients is provided a respective amount of access to one or more resources based on compliance with applicable said policies.

2. A computer-implemented method as described in claim 1, wherein the configuration items include patches, software versions and identified vulnerabilities to malicious parties.

3. A computer-implemented method as described in claim 1, wherein each of the clients is provided the respective amount of access to the one or more resources based on a relative level of compliance with applicable said policies.

4. A computer-implemented method as described in claim 1, wherein:
the plurality of clients are formed into groups based on tasks to be performed with respect to a business organization; and
each of the policies is directed toward a respective one of the groups.

5. A computer-implemented method as described in claim 1, wherein the plurality of clients forms at least a portion of an enterprise system.

6. A computer-implemented method as described in claim 1, wherein the respective amount of access to one or more resources is provided through varying quality of service in the use of the one or more resources.

7. A computer-implemented method as described in claim 1, wherein the respective amount of access to one or more resources is provided by impairing, restricting or disabling functionality of the client.

8. A computer-implemented method as described in claim 1, wherein:
the one or more resources include network access; and
the respective amount of access involves an amount of bandwidth made available based on the relative level of compliance of the respective clients with one or more of the policies.

9. A computer-implemented method as described in claim 1, wherein noncompliance with at least one said level of a respective said policy that is applicable to a particular said client causes the particular said client to be quarantined from accessing a network.

10. A computer-implemented method as described in claim 1, wherein at least one said policy specifies a remedial action to be taken to place a respective said client in compliance which is applied automatically and without user intervention through implementation of the at least one said policy.

11. A computer-implemented method as described in claim 1, wherein the implementing includes:
applying a first said policy that addresses an identified vulnerability such that at least one configuration setting is changed automatically and without user intervention to protect a respective said client from the identified vulnerability by disabling a resource of the respective said client; and
applying a second said policy that applies a remedy to the identified vulnerability and enables the resource.

12. A computer-implemented method as described in claim 11, wherein the remedy includes applying a patch, installing software or changing an existing configuration setting.

13. A computer-implemented method comprising:
examining data that describes configuration items of one or more clients to determine a relative level of compliance of the one or more clients with a policy; and
applying one of a plurality of different actions to respective said clients based on the determined level of compliance.

14. A computer-implemented method as described in claim 13, wherein at least one said action is to quarantine a respective said client.

15. A computer-implemented method as described in claim 13, wherein each said action corresponds to a respective said level of compliance.

16. A computer-implemented method as described in claim 13, wherein the policy specifies a plurality of levels of compliance for each of a plurality of the configuration items.

17. A computer-implemented method as described in claim 16, wherein the applying is performed based on a cumulative effect of noncompliance involving a plurality of the levels.

18. One or more computer-readable media comprising computer-executable instructions that are executable to monitor configuration items of a plurality of clients to determine compliance with one or more policies and when a deviation is detected in one or more configuration items, the one or more configuration items are modified automatically and without user intervention such that a respective said client complies with a respective said policy.

19. One or more computer-readable media as described in claim 18, wherein each of the clients is provided a respective amount of access to one or more resources based on a relative level of compliance with applicable said policies.

20. One or more computer-readable media as described in claim 19, wherein the respective amount of access to one or more resources is provided through varying quality of service in the use of the one or more resources.
